(19) United States
(12) Patent Application Publication
(10) Pub. No.: US 2015/0269436 A1
(43) Pub. Date: Sep. 24, 2015

(54) LINE SEGMENT TRACKING IN COMPUTER VISION APPLICATIONS

(71) Applicant: QUALCOMM Incorporated, San Diego, CA (US)

(72) Inventors: Kiyoung KIM, Vienna (AT); Gerhard REITMAYR, Graz (AT)

(21) Appl. No.: 14/657,821

(22) Filed: Mar. 13, 2015

Related U.S. Application Data
(60) Provisional application No. 61/955,071, filed on Mar. 18, 2014.

(51) Int. Cl. G06K 9/00; G06T 7/00

(52) U.S. Cl. CPC G06K 9/00624; G06T 7/0089

(57) ABSTRACT

Techniques are disclosed for tracking objects in computer vision (CV) applications, involving identifying line segments in an image and using iterative approach of computing and analyzing spatial and angular distribution of different sets of line segments to identify a set of line segments with relatively high spatial and/or angular distribution, which can reduce the likelihood of error in tracking. Some techniques may further employ a quality check of the selected line segments. An estimation of a device's pose (translation and orientation) may be calculated from tracked line segments.

This Application claims priority to co-pending U.S. application Ser. No. 61/955,071, entitled “LINE SEGMENT DETECTION AND MAPPING FOR SLAM,” filed on Mar. 18, 2014, the entire disclosure of which is hereby incorporated by reference in its entirety for all purposes.

### BACKGROUND

Computer vision (CV) applications can be executed by a mobile device (e.g., mobile phone, tablet, heads-up or head-mounted display, a wearable device, and the like) or other electronic device to provide a wide variety of features, such as augmented reality, mapping, and location tracking. These computer vision applications can utilize techniques such as simultaneous localization and mapping (SLAM) to build maps, update maps, and/or track a location of an electronic device. CV applications can utilize a series of images (such as video frames) to observe and track features, such as lines, in the environment. This tracking of features, however, can be difficult.

### SUMMARY

Techniques are disclosed for tracking objects in computer vision applications, involving identifying line segments in an image and using iterative approach of computing and analyzing spatial and angular distribution of different sets of line segments to identify a set of line segments with relatively high spatial and/or angular distribution, which can reduce the likelihood of error in tracking. Some techniques may further employ a quality check of the selected line segments. An estimation of a device's pose (translation and orientation) may be calculated from tracked line segments.

An example method of line segment detection and matching in a computer vision application, according to the disclosure, includes receiving at least one image of a physical environment, and identifying a plurality of line segments in the at least one image of the physical environment. The method further includes (i) selecting a first subset of the plurality of line segments in the image, (ii) computing an angular distribution and a spatial distribution of the first subset of the plurality of line segments, and (iii) determining whether the angular distribution and the spatial distribution of the first subset of the plurality of line segments satisfy predetermined angular and spatial criteria. The method also includes repeating (i), (ii), and (iii) with one or more new subsets of the of the plurality of line segments until a qualifying subset of the plurality of line segments is determined, the qualifying subset having a computed angular distribution and spatial distribution satisfying the predetermined angular and spatial criteria, and providing the qualifying subset of the plurality of line segments.

The example method can include one or more of the following features. The method may include determining a quality value for each line segment of the plurality of line segments, where selecting the first subset of the plurality of line segments is based on the quality value for each line segment. The quality value for each line segment of the plurality of line segments may be based on at least one of: a number of times the line segment has been observed in a series of successive images, a length of the line segment, a contrast value of the line segment, or an inverse reprojection error of the line segment. Selecting the first subset of the plurality of line segments in the image further may comprise dividing the image into a plurality of regions, and selecting the first subset of the plurality of line segments may be further based on a region in which each line segment is disposed. The method may include separating a line segment into multiple line segments, wherein a location of the separation is based on at least one boarder between regions of the plurality of regions. The image may be captured with a camera of a mobile device, further comprising calculating a pose of the mobile device based on the qualifying subset. The method may include, for each repetition of (i), (ii), and (iii), determining a value representative of a combination of the angular distribution and the spatial distribution. The method may further comprise determining a value for each of a plurality of subsets of the plurality of line segments, wherein the value of the qualifying subset represents the highest combined angular distribution and spatial distribution of the plurality of subsets. The method may further comprise computing a reprojection error of the qualifying subset. The qualifying subset may be a first qualifying subset, the method further comprising repeating (i), (ii), and (iii) to determine a second qualifying subset if the reprojection error of the first qualifying subset fails to satisfy a threshold condition. The plurality of line segments may correspond to a plurality of edges in the image.

An example apparatus enabling line segment detection and matching in a computer vision application, according to the description, comprises a memory, a camera configured to capture an image of a physical environment, and a processing unit communicatively coupled with the memory and the camera. The processing unit may be configured to receive at least one image of a physical environment and identify a plurality of line segments in the at least one image of the physical environment. The processing unit may be further configured to (i) select a first subset of the plurality of line segments in the image, (ii) compute an angular distribution and a spatial distribution of the first subset of the plurality of line segments, and (iii) determine whether the angular distribution and the spatial distribution of the first subset of the plurality of line segments satisfy predetermined angular and spatial criteria. The processing unit may also be configured to repeat (i), (ii), and (iii) with one or more new subsets of the of the plurality of line segments until a qualifying subset of the plurality of line segments is determined, the qualifying subset having a computed angular distribution and spatial distribution satisfying the predetermined angular and spatial criteria, and provide the qualifying subset of the plurality of line segments.

The apparatus may include one or more of the following features. The processing unit may be further configured to determine a quality value for each line segment of the plurality of line segments, where selecting the first subset of the plurality of line segments is based on the quality value for each line segment. The processing unit may be further configured to determine the quality value for each line segment of the plurality of line segments based on at least one of a number of times the line segment has been observed in a series of successive images, a length of the line segment, a contrast value of the line segment, or an inverse reprojection error of the line segment. The processing unit may be further configured to select the first subset of the plurality of line segments in the image further comprises dividing the image into a plurality of regions, and selecting the first subset of the plurality of line segments may be further based on a region in which each line segment is disposed. The processing unit may be further configured to separate a line segment into multiple line segments, wherein a location of the separation is based on at least one boarder between regions of the plurality of regions. The processing unit may be further configured to calculate a pose of the apparatus based on the qualifying subset. The processing unit may be further configured to, for each repetition of (i), (ii), and (iii), determine a value representative of a combination of the angular distribution and the spatial distribution. The processing unit may be further configured to determine a value for each of a plurality of subsets of the plurality of line segments, wherein the value of the qualifying subset represents the highest combined angular distribution and spatial distribution of the plurality of subsets. The the processing unit may be further configured to compute a reprojection error of the qualifying subset. The qualifying subset may be a first qualifying subset, the processing unit further configured to repeat (i), (ii), and (iii) to determine a second qualifying subset if the reprojection error of the first qualifying subset fails to satisfy a threshold condition.

An example device, according to the disclosure, comprises means for receiving at least one image of a physical environment and means for identifying a plurality of line segments in the at least one image of the physical environment. The device may further include means for performing the following functions: (iv) selecting a first subset of the plurality of line segments in the image, (v) computing an angular distribution and a spatial distribution of the first subset of the plurality of line segments, and (vi) determining whether the angular distribution and the spatial distribution of the first subset of the plurality of line segments satisfy predetermined angular and spatial criteria. The device further can comprise means for repeating (i), (ii), and (iii) with one or more new subsets of the of the plurality of line segments until a qualifying subset of the plurality of line segments is determined, the qualifying subset having a computed angular distribution and spatial distribution satisfying the predetermined angular and spatial criteria, and means for providing the qualifying subset of the plurality of line segments.

The device may include one or more of the following features. The device may include means for determining a quality value for each line segment of the plurality of line segments, where selecting the first subset of the plurality of line segments is based on the quality value for each line segment. The image may be captured with a camera of a mobile device, further comprising means for calculating a pose of the mobile device based on the qualifying subset. The device may further comprise means for determining, for each repetition of (i), (ii), and (iii), a value representative of a combination of the angular distribution and the spatial distribution. The device may further comprise means for determining a value for each of a plurality of subsets of the plurality of line segments, wherein the value of the qualifying subset represents the highest combined angular distribution and spatial distribution of the plurality of subsets. The device may further comprise means for computing a reprojection error of the qualifying subset.

An example non-transitory computer-readable medium, according to the disclosure, comprises instructions embedded thereon enabling line segment detection and matching in a computer vision application. The instructions include code, executable by one or more processors, for receiving at least one image of a physical environment, and identifying a plurality of line segments in the at least one image of the physical environment. The instructions further include code for (i) selecting a first subset of the plurality of line segments in the image, (ii) computing an angular distribution and a spatial distribution of the first subset of the plurality of line segments, and (iii) determining whether the angular distribution and the spatial distribution of the first subset of the plurality of line segments satisfy predetermined angular and spatial criteria. The instructions further include code for repeating (i), (ii), and (iii) with one or more new subsets of the of the plurality of line segments until a qualifying subset of the plurality of line segments is determined, the qualifying subset having a computed angular distribution and spatial distribution satisfying the predetermined angular and spatial criteria, and providing the qualifying subset of the plurality of line segments.

The non-transitory computer-readable medium can further include one or more of the following features. The instructions may include code for calculating a pose of a mobile device based on the qualifying subset. The instructions may include code for computing a reprojection error of the qualifying subset.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIGS. 1A-1C are simplified drawings of an example image to help illustrate problems that can arise in the tracking of features in a series of images.

FIGS. 2A and 2B help illustrate how using line segments with spatial and angular diversity can help the alignment and matching of line segments, which can be identified and utilized according to techniques described herein.

FIG. 3 is a process flow diagram of a process by which distributed line segments with angular diversity may be selected for tracking purposes, according to one embodiment.

FIGS. 4A and 4B are simplified illustrations of an image subject to the process described in FIG. 3, according to one embodiment.

FIG. 4C is graph illustrating the angular distribution of the selected line segments of FIG. 4B.

FIG. 5 is a flow diagram of a method of implementing the process shown in FIGS. 3 and 4A-4C, according to an embodiment.

FIG. 6 is a block diagram of an embodiment of a mobile device, which can implement the techniques for line segment selection in tracking discussed herein.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

Simultaneous localization and mapping (SLAM) techniques can be implemented by a variety of electronic devices to provide location tracking, mapping, and more. Among other things, such SLAM techniques can be used in mobile devices to help determine the devices translation and orientation (i.e., 6 degrees of freedom, or “pose”). Furthermore, a mobile device can use visual SLAM techniques that utilize visual images, such as video frames from the mobile device's camera, to determine movement of the mobile device by comparing one image to the next.

Line matching is a technique used in visual SLAM to track line segments in three dimensions (3D lines) by matching a line segment in a first image with the corresponding line segment in a second image. This enables the visual SLAM to determine how an object associated with the tracked line segments has moved in relation to the mobile device from the first image to the second image, thereby enabling the visual SLAM to determine how the pose of the mobile device may have changed from the first image to the second image (in cases where the object is stationary and the mobile device is moving). For accurate tracking, the line segments in various successive images must be properly matched, otherwise, there can be a misalignment in the tracking, which can result in an incorrect pose calculation and/or other errors.

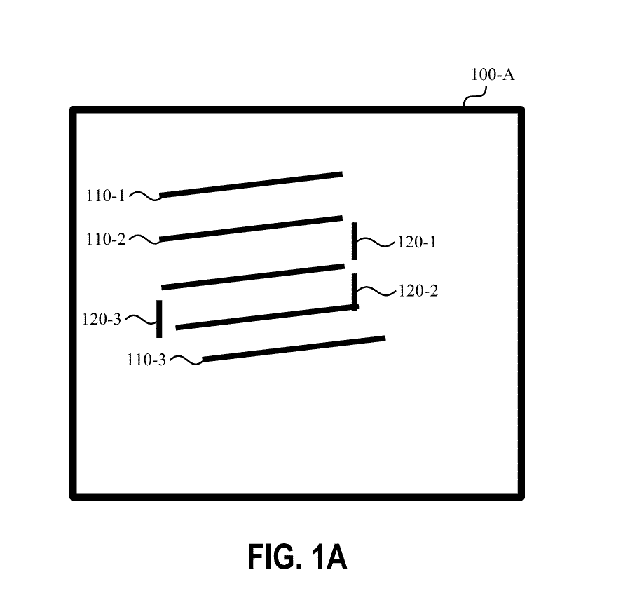

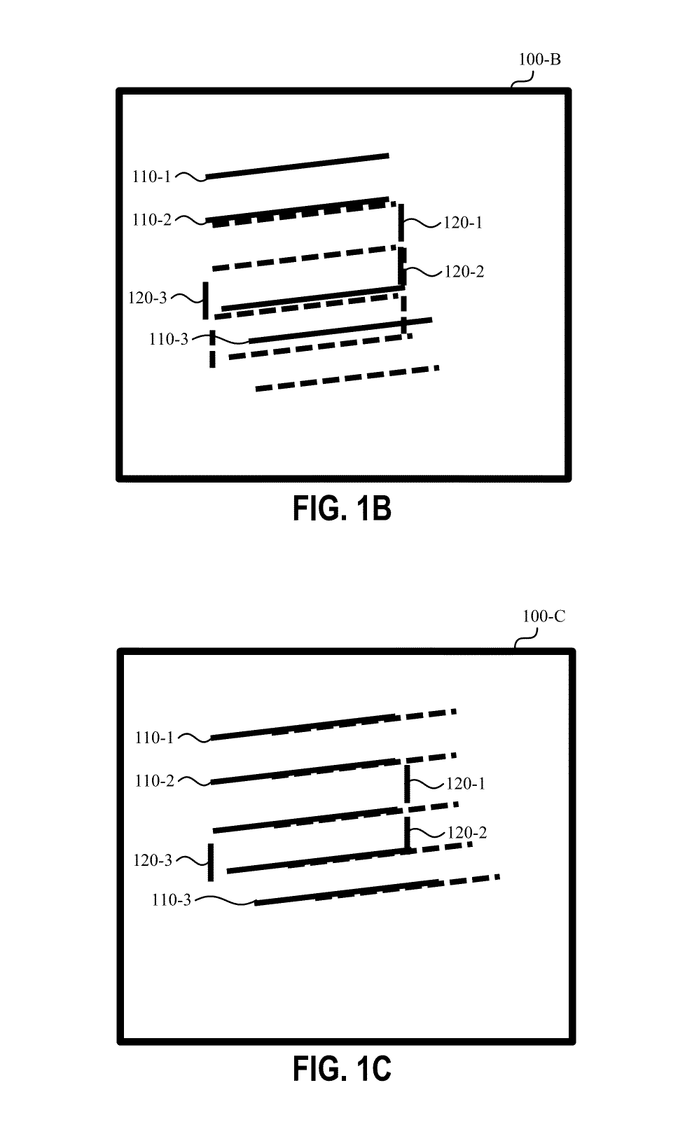

FIGS. 1A-1C are simplified drawings of an example image that helps illustrate problems that can arise in tracking. FIG. 1A illustrates an image 100-A having a plurality of line segments 110 and 120, including line segments that are substantially horizontal 110 and line segments that are substantially vertical 120 (note that, for clarity, only a portion of line segments 110 and 120 are labeled in FIG. 1A). The image can be an image captured by mobile device's camera of the mobile device's physical environment. The image 100-A may be, for example, a frame of video. In some embodiments, the image 100-A may be utilized by applications other than CV applications. In other embodiments, the image 100-A may be utilized by a CV application exclusively, or may be used by a CV application in addition to one or more other applications executed by a mobile device or other electronic device. In some embodiments, the image 100-A may be derived from an image of a physical environment, having features extracted from the image of the physical environment.

The line segments 110, 120 may include and/or be derived from or representative of edges and/or other features in an image of a physical environment. Basic image processing, such as edge detection and/or other algorithms may be used to create and/or identify such line segments 110, 120. Because line segments can be easily derived from images, they can be used in visual SLAM and/or other CV applications for tracking the pose of a device. However, the similarity of the substantially horizontal line segments 110 and/or the substantially vertical line segments 120 can make tracking such line segments more difficult.

FIGS. 1B and 1C are simplified drawings showing line segment mismatch and other tracking errors. FIG. 1B, for example, illustrates an image 100-B in which line segments from a previously-captured image (represented in FIG. 1B as dashed lines) corresponding to the line segments of the image 100-A in FIGS. lA are improperly matched to their corresponding line segments. Here, due to the similarity of substantially horizontal line segments 110-1 and 110-2 and/or the similarity of substantially vertical line segments 120-1 and 120-2 the line segments from the previously-captured image are matched too low, such that the line segment that should be matched to line segment 110-1 is matched to line segment 110-2, and the line segment that should be matched to line segment 120-1 is matched to line segment 120-2. Furthermore, the spacing of the substantially horizontal lines 110 is such that the matching of the line segments from the previously-captured image essentially shifts each substantially horizontal line down by one line.

FIG. 1C illustrates another tracking problem that can arise due to the use of lines with little angular diversity (i.e., a relatively small angular distribution). In FIG. 1C, an image 100-C is shown in which line segments from a previously-captured image (represented again as dashed lines) are improperly matched to the line segments in image 100-A of FIG. 1. Here, the substantially vertical line segments are not utilized for tracking. As illustrated in FIG. 1B, the similarity of line segments 120-1 and 120-2 led to the incorrect matching of line segments. However, as shown in FIG. 1C, although disregarding the substantially vertical line segments in tracking may help ensure that the substantially horizontal line segments from the previously-captured image are matched correctly (e.g., the line segment that should be matched to line segment 110-1 is indeed matched to line segment 110-1), the matching is misaligned horizontally because there are no tracked lines to provide a horizontal reference point (which the substantially vertical lines had previously done).

The problems shown in FIGS. 1B and 1C illustrate the difficulties that can arise in tracking when there is little spatial or angular distribution among tracked line segments. In FIG. 1B, for example, all line segments were used for tracking, including all of the substantially horizontal line segments 110, which were similar and had relatively little spatial diversity (i.e., the lines were relatively close). In FIG. 1C, only the substantially horizontal line segments 110 were used for tracking, resulting in difficulty in achieving a correct horizontal alignment.

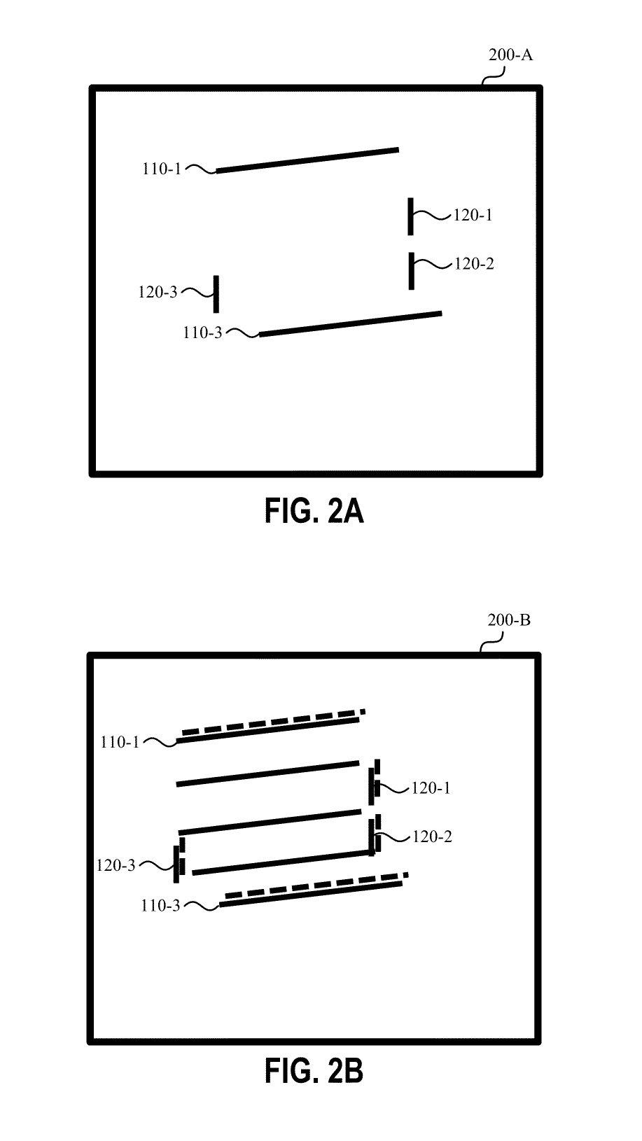

FIGS. 2A and 2B help illustrate how using line segments with spatial and angular diversity can help the alignment and matching of line segments, which can be identified and utilized according to techniques described herein. FIG. 2A, for example, is a FIG. 200-A that illustrates which line segments of image 100-A of FIG. lA can be used for tracking purposes. In particular, FIG. 2A illustrates substantially horizontal line segments 110-1 and 110-3, as well as substantially vertical line segments 120-1, 120-2, and 120-3. As can be seen, these line segments are roughly at the periphery of the line segments in the image 100-A of FIG. lA thereby having a large spatial distribution. Additionally, because the line segments of FIG. 2A include both substantially vertical line segments 120 and substantially horizontal line segments, the line segments for tracking, as illustrated in FIG. 2A, are also relatively diverse angularly.

FIG. 2B illustrates how a selected subset of line segments from a previously-captured image (shown as dashed lines) used for tracking purposes, corresponding to the line segments illustrated in FIG. 2A, are then matched to the line segments in the image 100-A of FIG. 1A. Unlike in FIG. 1B, which used all the line segments for line matching, or FIG. 1C, which used only substantially horizontal line segments for matching, the selected subset of line segments used for matching include angularly- and spatially-diverse line segments as shown in FIG. 2A. Here, the matching and alignment are approximately correct because of well-conditioned line segments for pose refinement.

It can be noted that, in the embodiment above, lines used for tracking (dashed lines in FIGS. 1B, 1C, and 2A) are described as being obtained from a previously-captured image and applied to a previous image for tracking. Depending on desired functionality, embodiments may additionally or alternatively obtain lines for tracking from a subsequently-captured image and match them to lines of a previously-captured image. A person of ordinary skill in the art will recognize many variations in the implementation and/or applicability of the embodiments herein.

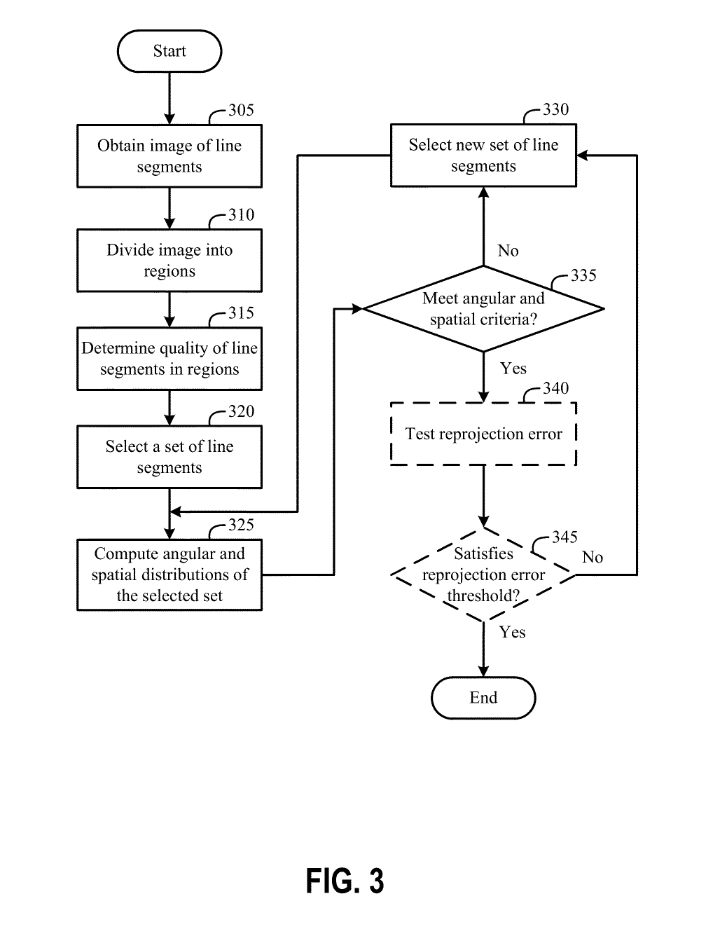

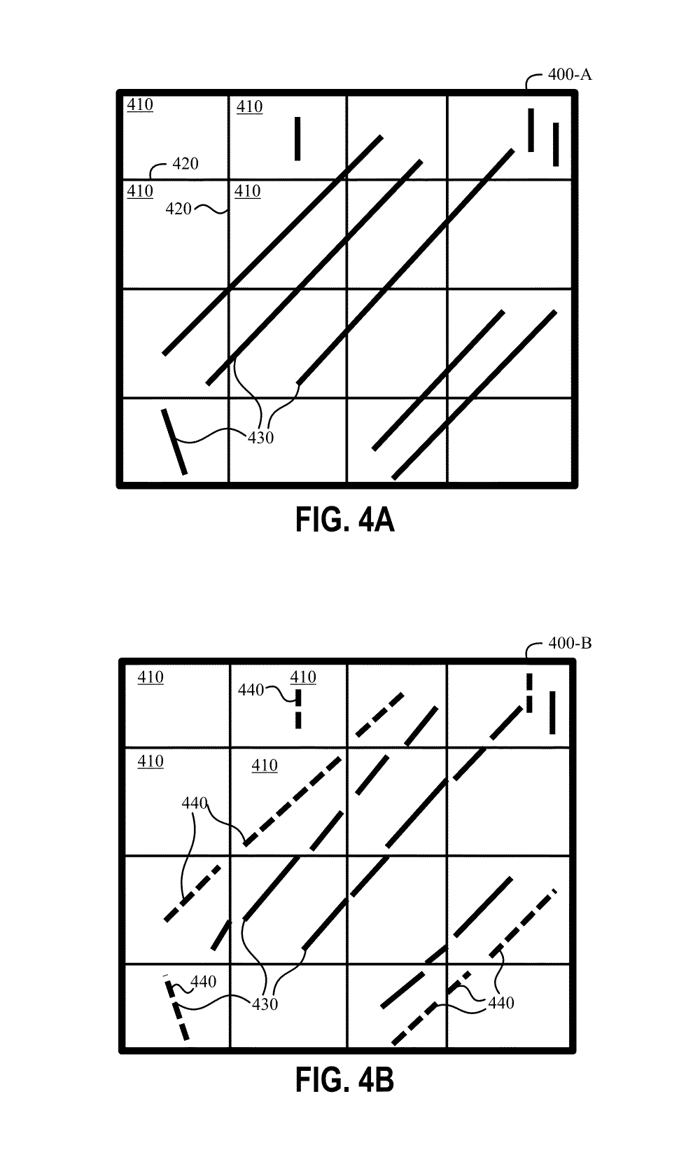

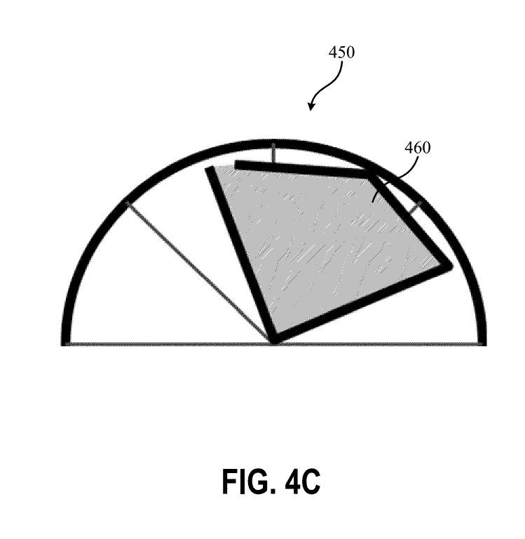

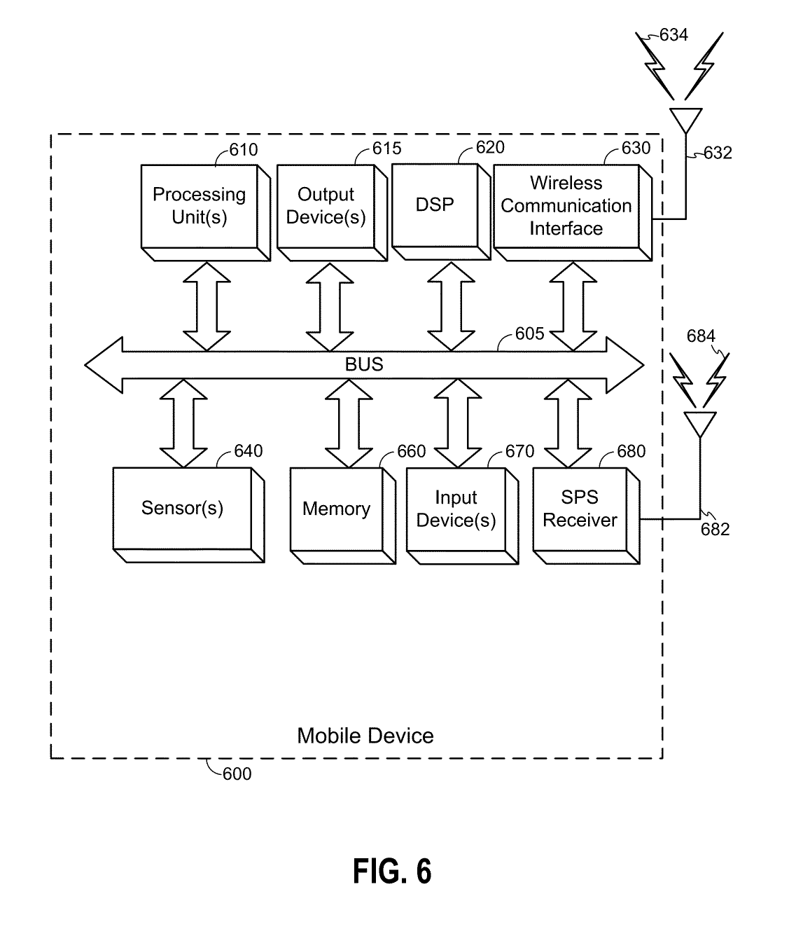

FIG. 3, in reference to FIGS. 4A-4C, is a process flow diagram of a process by which distributed (i.e., spatially diverse) line segments with angular diversity may be selected for tracking purposes, according to one embodiment. Means for performing one or more of the functions described can include one or more components of a computing system, such as the mobile device illustrated in FIG. 6. Also, depending on desired functionality, alternative embodiments may add, omit, combine, separate, the functionality shown in the blocks of FIG. 3, and my also execute multiple blocks simultaneously. A person of ordinary skill in the art will recognize many variations.

At block 305 of FIG. 3, an image of line segments is first obtained. As indicated above, an image may be of a physical environment and may be captured, for example, by a mobile device's camera. The image may be, for example, a frame of video. The image may be processed using edge detection and/or other algorithms to identify a plurality of line segments, which may pertain to edges in the physical environment (e.g., edges dividing regions of different brightness, color, and/or other attributes of the pixels in the image.). Some or all of the line segments may be representative of line segments tracked in three dimensions (3D lines) by a visual SLAM or other CV application. Means for performing the function at block 305 can include, for example, the processing unit(s) 610, bus 605, memory 660, sensor(s) 640 (such as a camera), DSP 620, wireless communication interface 630, and/or other software or hardware components of a mobile device as shown in FIG. 6.

At block 310, the image is then divided into regions. FIG. 4A illustrates how an example image 400-A (obtained, for example, at block 305 of the process shown in FIG. 3) having line segments 430 is divided up into regions 410 with gridlines 420. (To avoid clutter, only a small portion of regions 410, gridlines 420, and line segments 430 have been labeled in FIG. 4A.) Here, the image is divided into a 4x4 grid with 16 regions. However, different embodiments may include a grid with a larger or smaller number of regions (e.g., an NxN or NxM grid). Depending on functionality, embodiments may include regions 410 that are non-rectangular and/or regions of differing sizes (e.g., where a first region in an image is larger or smaller than a second region in the image). Means for performing the function at block 310 can include, for example, the processing unit(s) 610, memory 660, DSP 620, and/or other software or hardware components of a mobile device as shown in FIG. 6.

At block 315 of FIG. 3, the quality of each of the line segments in each region can be determined. For convenience, line segments that pass from one region into another may be split (e.g., at or near the boundary of the regions), as illustrated in FIG. 4B. FIG. 4B illustrates an image 400-B corresponding to the image 400-A of FIG. 4A, but with line segments 430 spit at roughly the boundary between regions. (Again, only a portion of line segments 430 of FIG. 4B are labeled. Furthermore, selected line segments 440, which are described in more detail below, are represented by dashed lines to distinguish them from other line segments 430. Thus, breaks in these selected line segments 440 within regions are not “splits” as described here, but are instead simply breaks between the dashes in these dashed lines.)

The quality of line segments can be determined in any of a variety of ways. Here, “quality” is any way in which line segments may be rated and/or ranked for selection purposes. Quality can include factors such as the number of observations (e.g., the number of successive images in which a line segment occurs, in embodiments where images from video are utilized), length, magnitude (e.g., the level of contrast or gradient that a line segment has in the image), inverse reprojection error, and the like. Such factors may be quantified and added to determine an overall measure of quality. Some embodiments may provide different weights to the various factors, depending on a level of importance each factor may have in determining the overall measure of quality. Such weightings can be easily obtained, for example, through observation and/or experiment. In some embodiments, lines may be rated by factors in addition to or as an alternative of quality. Means for performing the function at block 315 can include, for example, the processing unit(s) 610, bus 605, memory 660, DSP 620, and/or other software or hardware components of a mobile device as shown in FIG. 6.

Referring again to FIG. 3, at block 320 a set of line segments is selected. Line segments in this set can be selected based on their respective measure of quality. For example, in FIG. 4B, each region 410 having a line segment may be analyzed to determine which line segment has the highest measure of quality in the region. The line segments with the highest measure of quality for each region, for instance, may be initially selected. Here, the “selection” of line segments means that the selected line segments may be used for tacking purposes (i.e., line matching) if they meet certain thresholds, as described in more detail below. Means for performing the function at block 320 can include, for example, the processing unit(s) 610, bus 605, memory 660, DSP 620, and/or other software or hardware components of a mobile device as shown in FIG. 6.

At blocks 325 and 335 of FIG. 3, the angular and spatial distributions of the selected set of line segments are computed, then tested against certain criteria (details regarding these angular and spatial distribution criteria—such as minimum angular distribution and/or minimum spatial distribution—are provided in more detail below). When spatial and/or angular distributions fail to meet the criteria, a new set of line segments is selected at block 330, and the process returns to block 325 for the determination and testing of the angular and spatial distributions of the newly-selected set. Thus, an iterative approach can be used to determine angular and spatial distributions. When spatial and angular distributions meet the criteria, the process can optionally continue to block 340 as described in further detail below. As seen in embodiments herein, where line segments for a particular region fail to meet angular and/or spatial distribution criteria, the process of FIG. 3 may result in no line segments in the particular region being selected. Furthermore, the lines selected in the iterative process of blocks 325-335 may be subject to satisfying additional criteria, as detailed below, which may result in line reselection.

Any of a variety of methods may be used in selecting a new set of line segments. Selecting a new set of line segments may be in relation to a previously-selected set, for example modifying a previously-selected set by adding and/or omitting a line segment, and/or selecting an alternative line segment to include in the new set of line segments. Such alterations may occur in an order that is based on region. For example, starting at a first region in the upper left-hand corner of the image and making an alteration to the selected line segment(s) (if any) in that region. During the iterative process, if all alterations to this first region are exhausted, moving to the next region (e.g., the region to the first region's right), exhausting options in that region, and so on. In some embodiments, a single alteration may be made to the first region before moving to the next. In some embodiments, groups of regions may be selected for alterations before other regions are altered. A person of ordinary skill in the art will recognize many variations are possible.

Some embodiments may involve selecting a spatial distribution first (iterating through the process of selecting a set of line segments, calculating spatial distribution, and determining whether the spatial distribution meets a threshold) before selecting an angular distribution (again, through an iterative approach), or vice versa. For example, some embodiments could first go through a process of determining a satisfactory spatial distribution by computing spatial distribution of a selected set of line segments, then determining whether it meets a certain threshold of spatial diversity. Alternatively, rather than a spatial threshold, it could iterate through a process of selecting new sets of line segments and computing the spatial distribution (for example, for a specified number or range of iterations), and selecting the set of line segments with the greatest spatial distribution. Embodiments could then use similar thresholds and/or iterative processes in determining a line set with angular diversity. (Here, the iterative process may examine the same sets of line segments used in the spatial distribution iterative approach, and a set of line segments could be selected that balances spatial and angular distributions, or, with each iteration in determining angular distribution, a newly-selected line set is first vetted to determine whether it satisfies spatial distribution criteria, using the iterative approach for determining spatial distribution described above.) Means for performing the function at blocks 325, 330, and/or 335 can include, for example, the processing unit(s) 610, bus 605, memory 660, DSP 620, and/or other software or hardware components of a mobile device as shown in FIG. 6.

Referring again to FIG. 4B, the dashed line segments 440 in the image 400-B indicate line segments from the image 400-A of FIG. 4A that were selected for line matching with lines from a subsequently- or previously-captured image, using the iterative process for determining spatial and angular distribution of line segments. As can be seen the selected lines 440 are generally in the periphery of the line segments 430 of the image (i.e., spatially distributed), and include line segments with relatively good angular distribution. FIG. 4C includes a graph 450 that illustrates the angular distribution 460 of the selected lines 440 of FIG. 4B over 180 degrees. As shown in FIG. 4B the process of selecting spatially- and angularly-diverse line segments may involve selecting line segments from only some of the regions 410 having line segments 430. (If, for example, a first set of line segments includes a selected line segment from each region 410, the iterative process of selecting new line segments to achieve spatial and angular diversity may involve unselecting line segments that were selected in a previous set of line segments such that only a portion of the regions with line segments have selected line segments). Having selected a set of line segments 440 with spatial and angular diversity to use for line matching, object tracking in a visual SLAM or other CV application is less likely to suffer the problems illustrated in FIGS. 1B and 1C.

Additional tests may be conducted to determine whether tracking using the selected line segments is satisfactory. One such test utilized in visual SLAM and other CV applications, as shown at optional blocks 340 and 345 of FIG. 3, is determining whether a reprojection error of the selected line segments satisfy an error threshold. That is, the reprojection of the selected line segments (which is used in tracking) can be calculated, and the reprojection error (or difference between reprojected line segments and observed line segments in the subsequently- or previously-captured image) can be determined, at block 340. Optionally, at block 345, if the difference between the reprojected line segments and the corresponding observed line segment satisfies a threshold (for example, is within two pixels), the selected line segments are deemed to have resulted in satisfactory tracking. Otherwise, if it fails to satisfy an error threshold, a new set of line segments is selected at block 330, and the iterative process of selecting a set of lines with spatial and angular diversity begins again. Means for performing the function at blocks 340 and 345 can include, for example, the processing unit(s) 610, bus 605, memory 660, sensor(s) 640, DSP 620, and/or other software or hardware components of a mobile device as shown in FIG. 6.

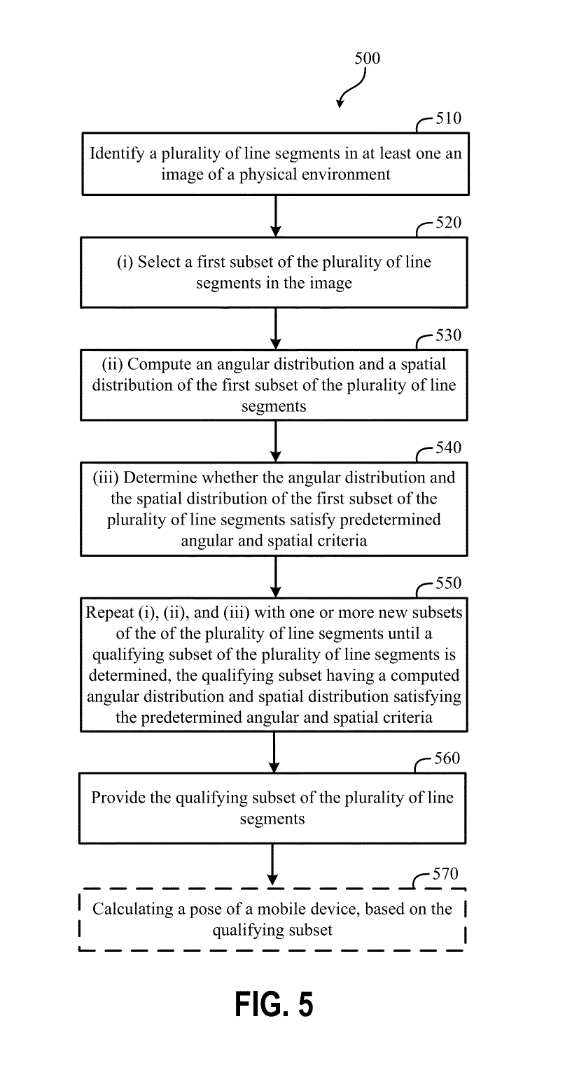

FIG. 5 is a flow diagram of a method 500 of implementing the process shown in FIGS. 3 and 4A-4C, according to an embodiment. Other embodiments may alter the components of the method 500 shown, by, for example, combining, separating, omitting, or adding to the blocks shown in FIG. 5. Additionally or alternatively, embodiments may perform the functionality in a different order or simultaneously. A person of ordinary skill in the art will recognize many such variations.

At block 510, a plurality of line segments in at least one image are identified. As previously indicated, the at least one image may be an image of a physical environment, which may be, for example, captured with or received from a camera of a mobile device. The line segments may correspond to edges in the at least one image. The at least one image may undergo certain processing, such as edge detection, to identify the line segments in the image. Means for performing the functionality at block 510 can include, for example, the processing unit(s) 610, bus 605, memory 660, DSP 620, and/or other software or hardware components of a mobile device as shown in FIG. 6.

Block 520 includes the functionality of one of three functions (labeled (i), (ii), and (iii), respectively) performed iteratively to help determine a qualifying subset of the plurality of line segments. The functionality described at block 520 comprises selecting a first subset of the plurality of line segments in the image. As discussed above, the selection of the first subset of the plurality of line segments may be facilitated by first dividing the image into a plurality of regions. (These regions may be used in the selection of subsequent subsets, as previously described). Line segments may also be separated (e.g., into smaller line segments), where the location of the separation is based on the border between regions. The selection of line segments can be based on a quality value determined for each line segment, where quality can be based on a variety of factors, such as a number of times the line segment has been observed in a series of successive images (of which the at least one image of blocks 510 and 520 is a part), a length of the line segment, a contrast value (i.e., magnitude) of the line segment, and/or an inverse reprojection error of the line segment. Means for performing the functionality at block 520 can include, for example, the processing unit(s) 610, bus 605, memory 660, DSP 620, and/or other software or hardware components of a mobile device as shown in FIG. 6.

Function (ii), at block 530, includes computing an angular and spatial distribution of the first subset of the plurality of line segments. Function (iii), at block 540, includes determining whether the angular distribution and spatial distribution of the first subset of the plurality of line segments satisfy angular and spatial criteria. As previously indicated a subset with relatively high angular and spatial distributions is preferable over a subset with relatively low angular and spatial distributions for tracking in visual SLAM or other CV applications. To find such a subset, functions (i), (ii), and (iii) (in blocks 520, 530, and 540, respectively) are repeated, as shown in block 550, with one or more new subsets of the plurality of line segments, selected (for example, using the techniques previously described) for each repetition until a qualifying subset is determined Here, a “qualifying subset” is a subset having a computed angular distribution and spatial distribution that satisfies predetermined angular and spatial criteria. Some embodiments may iterate through functions (i)-(iii) with new subsets even after a qualifying subset is found (e.g., for a threshold or predefined number of iterations), to determine whether a better subset exists. If so, the better subset may be used as the qualifying subset. Otherwise the original qualifying subset may be used. At block 560, the qualifying subset of the plurality of line segments is provided (e.g., provided to a hardware and/or software application which can utilize the qualifying subset in tracking objects in computer vision applications). Means for performing the functionality at blocks 530, 540, 550, and/or 560 can include, for example, the processing unit(s) 610, bus 605, memory 660, DSP 620, and/or other software or hardware components of a mobile device as shown in FIG. 6.

Depending on desired functionality, any of a variety of angular and spatial criteria may be used. In some embodiments, for example, angular and spatial criteria could require angular and/or spatial distributions to meet certain thresholds. Additionally or alternatively, a qualifying subset may satisfy angular and spatial criteria by being the subset with the highest angular and/or spatial distributions of the subsets for which for which angular and spatial distributions are calculated at function (ii).

In one embodiment, a value could be given to each subset for which angular and spatial distributions are calculated at function (ii). The value can be, for example, representative of a combination of the angular distribution and spatial distribution (e.g., a value could be given to each distribution, and then added to produce a value representative of the combination). The value may weigh angular and spatial distributions differently, depending on desired functionality. Thus, determining the qualifying subset is a matter of determining the subset with the value that represents the highest combined angular distribution and spatial distribution from among the subsets for which these distributions were calculated (e.g., the subset with the highest value).

Optionally, at block 570, a pose of a mobile device is calculated, based on the qualifying subset. As previously indicated, the method 500 can be used for tracking visual objects in CV application. In visual SLAM, such tracking can be used to determine the pose of a mobile device. In such instances, the pose can be determined, based on the qualifying subset, where the image is taken with a camera of the mobile device.

Also, as discussed above, the qualifying subset may be subject to quality controls and/or other tests to help ensure it can be used for accurate tracking. One such test involves calculating the reprojection error of the qualifying subset and determining whether it satisfies an error threshold. If the threshold is not met, the functions (i)-(iii) can be repeated with new subsets to determine a new qualifying subset. This process may be repeated until a qualifying subset having a reprojection error that satisfies the error threshold is found. Means for performing the functionality at block 530 can include, for example, the processing unit(s) 610, bus 605, memory 660, DSP 620, and/or other software or hardware components of a mobile device as shown in FIG. 6.

FIG. 6 is a block diagram of an embodiment of a mobile device 600 (e.g., mobile phone, tablet, heads-up or head-mounted display, a wearable device, and the like), which can implement visual SLAM and/or other CV applications, as well as the techniques discussed herein for determining a set of lines for line matching in tracking. It should be noted that FIG. 6 is meant only to provide a generalized illustration of various components, any or all of which may be utilized as appropriate. Moreover, system elements may be implemented in a relatively separated or relatively more integrated manner Additionally or alternatively, some or all of the components shown in FIG. 6 can be utilized in another computing device, which can be used in conjunction with a mobile device 600 as previously described.

The mobile device 600 is shown comprising hardware elements that can be electrically coupled via a bus 605 (or may otherwise be in communication, as appropriate). The hardware elements may include a processing unit(s) 610 which can include without limitation one or more general-purpose processors, one or more special-purpose processors (such as digital signal processors (DSPs), graphics acceleration processors, application specific integrated circuits (ASICs), and/or the like), and/or other processing structure or means, which can be configured to perform one or more functions of the methods described herein, such as the processes and methods shown in FIGS. 3 and 5. As shown in FIG. 6, some embodiments may have a separate DSP 620, depending on desired functionality. The mobile device 600 also can include one or more input devices 670, which can include without limitation one or more camera(s), a touch screen, a touch pad, microphone, button(s), dial(s), switch(es), and/or the like; and one or more output devices 615, which can include without limitation a display, light emitting diode (LED), speakers, and/or the like.

The mobile device 600 might also include a wireless communication interface 630, which can include without limitation a modem, a network card, an infrared communication device, a wireless communication device, and/or a chipset (such as a Bluetooth™ device, an IEEE 802.11 device, an IEEE 802.15.4 device, a WiFi device, a WiMax device, cellular communication facilities, etc.), and/or the like. The wireless communication interface 630 may permit data to be exchanged with a network, wireless access points, other computer systems, and/or any other electronic devices described herein. The communication can be carried out via one or more wireless communication antenna(s) 632 that send and/or receive wireless signals 634.

The mobile device 600 can further include sensor(s) 640, as previously described. Such sensors can include, without limitation, one or more accelerometer(s), gyroscope(s), camera(s), magnetometer(s), altimeter(s), microphone(s), proximity sensor(s), light sensor(s), and the like. At least a subset of the sensor(s) 640 can provide image capture and/or inertial information used in visual SLAM.

Embodiments of the mobile device may also include a Satellite Positioning System (SPS) receiver 680 capable of receiving signals 684 from one or more SPS satellites using an SPS antenna 682. Such positioning can be utilized to complement and/or incorporate the techniques described herein. It can be noted that, as used herein, an SPS may include any combination of one or more global and/or regional navigation satellite systems and/or augmentation systems, and SPS signals may include SPS, SPS-like, and/or other signals associated with such one or more SPS. GPS is an example of an SPS.

The mobile device 600 may further include and/or be in communication with a memory 660. The memory 660 can include, without limitation, local and/or network accessible storage, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data structures, store images, line segment selection, and/or perform other memory functions that may be utilized by the techniques described herein, and may be allocated by hardware and/or software elements of a mobile device 600. Additionally or alternatively, data structures described herein can be implemented by a cache or other local memory of a DSP 620 or processing unit(s) 610. Memory can further be used to store an image stack, inertial sensor data, and/or other information described herein.

The memory 660 of the mobile device 600 also can comprise software elements (not shown), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above, such as the processes and methods shown in FIGS. 3 and 5, might be implemented as code and/or instructions executable by the mobile device 600 (and/or processing unit(s) 610 within a mobile device 600) and/or stored on a non-transitory and/or machine-readable storage medium (e.g., a “computer-readable storage medium,” a “machine-readable storage medium,” etc.). In an aspect, then, such code and/or instructions can be used to configure and/or adapt a general purpose processor (or other device) to perform one or more operations in accordance with the described methods.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Computer Vision (CV) applications that utilize visual SLAM (including the techniques described herein) can include a class of applications related to the acquisition, processing, analyzing, and understanding of images. CV applications include, without limitation, mapping, modeling—including 3D modeling, navigation, augmented reality applications, and various other applications where images acquired from an image sensor are processed to build maps, models, and/or to derive/represent structural information about the environment from the captured images. In many CV applications, geometric information related to captured images may be used to build a map, model, and/or other representation of objects and/or other features in a physical environment. Although specific embodiments discussed herein may utilize SLAM (and, in particular, visual SLAM), embodiments may utilize other, similar features.

It can be further noted that, although examples described herein are implemented by a mobile device, embodiments are not so limited. Embodiments can include, for example, personal computers and/or other electronics not generally considered “mobile.” A person of ordinary skill in the art will recognize many alterations to the described embodiments.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several example configurations, various modifications, alternative constructions, and equivalents may be used without departing from the scope of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

What is claimed is:

1. A method of line segment detection and matching in a computer vision application, the method comprising:
receiving at least one image of a physical environment;
identifying a plurality of line segments in the at least one image of the physical environment;
(i) selecting a first subset of the plurality of line segments in the image;
(ii) computing an angular distribution and a spatial distribution of the first subset of the plurality of line segments;
(iii) determining whether the angular distribution and the spatial distribution of the first subset of the plurality of line segments satisfy predetermined angular and spatial criteria;
repeating (i), (ii), and (iii) with one or more new subsets of the of the plurality of line segments until a qualifying subset of the plurality of line segments is determined, the qualifying subset having a computed angular distribution and spatial distribution satisfying the predetermined angular and spatial criteria; and
providing the qualifying subset of the plurality of line segments.

2. The method of claim 1, further comprising determining a quality value for each line segment of the plurality of line segments, wherein selecting the first subset of the plurality of line segments is based on the quality value for each line segment.

3. The method of claim 2, wherein the quality value for each line segment of the plurality of line segments is based on at least one of:
a number of times the line segment has been observed in a series of successive images,
a length of the line segment,
a contrast value of the line segment, or
an inverse reprojection error of the line segment.

4. The method of claim 2, wherein selecting the first subset of the plurality of line segments in the image further comprises dividing the image into a plurality of regions, and wherein selecting the first subset of the plurality of line segments is further based on a region in which each line segment is disposed.

5. The method of claim 4, further comprising separating a line segment into multiple line segments, wherein a location of the separation is based on at least one boarder between regions of the plurality of regions.

6. The method of claim 1, wherein the image is captured with a camera of a mobile device, further comprising calculating a pose of the mobile device based on the qualifying subset.

7. The method of claim 1, further comprising, for each repetition of (i), (ii), and (iii), determining a value representative of a combination of the angular distribution and the spatial distribution.

8. The method of claim 7, further comprising determining a value for each of a plurality of subsets of the plurality of line segments, wherein the value of the qualifying subset represents the highest combined angular distribution and spatial distribution of the plurality of subsets.

9. The method of claim 1, further comprising computing a reprojection error of the qualifying subset.

10. The method of claim 9, wherein the qualifying subset is a first qualifying subset, the method further comprising repeating (i), (ii), and (iii) to determine a second qualifying subset if the reprojection error of the first qualifying subset fails to satisfy a threshold condition.

11. The method of claim 1, wherein the plurality of line segments correspond to a plurality of edges in the image.

12. An apparatus enabling line segment detection and matching in a computer vision application, the apparatus comprising:
a memory;
a camera configured to capture an image of a physical environment;
a processing unit communicatively coupled with the memory and the camera and configured to:
receive at least one image of a physical environment;
identify a plurality of line segments in the at least one image of the physical environment;
(i) select a first subset of the plurality of line segments in the image;
(ii) compute an angular distribution and a spatial distribution of the first subset of the plurality of line segments;
(iii) determine whether the angular distribution and the spatial distribution of the first subset of the plurality of line segments satisfy predetermined angular and spatial criteria;
repeat (i), (ii), and (iii) with one or more new subsets of the of the plurality of line segments until a qualifying subset of the plurality of line segments is determined, the qualifying subset having a computed angular distribution and spatial distribution satisfying the predetermined angular and spatial criteria; and
provide the qualifying subset of the plurality of line segments.

13. The apparatus of claim 12, wherein the processing unit is further configured to determine a quality value for each line segment of the plurality of line segments, wherein selecting the first subset of the plurality of line segments is based on the quality value for each line segment.

14. The apparatus of claim 13, wherein the processing unit is further configured to determine the quality value for each line segment of the plurality of line segments based on at least one of:
a number of times the line segment has been observed in a series of successive images,
a length of the line segment,
a contrast value of the line segment, or
an inverse reprojection error of the line segment.

15. The apparatus of claim 13, wherein the processing unit is further configured to select the first subset of the plurality of line segments in the image further comprises dividing the image into a plurality of regions, and wherein selecting the first subset of the plurality of line segments is further based on a region in which each line segment is disposed.

16. The apparatus of claim 15, wherein the processing unit is further configured to separate a line segment into multiple line segments, wherein a location of the separation is based on at least one boarder between regions of the plurality of regions.

17. The apparatus of claim 12, wherein the processing unit is further configured to calculate a pose of the apparatus based on the qualifying subset.

18. The apparatus of claim 12, wherein the processing unit is further configured to, for each repetition of (i), (ii), and (iii), determine a value representative of a combination of the angular distribution and the spatial distribution.

19. The apparatus of claim 18, wherein the processing unit is further configured to determine a value for each of a plurality of subsets of the plurality of line segments, wherein the value of the qualifying subset represents the highest combined angular distribution and spatial distribution of the plurality of subsets.

20. The apparatus of claim 12, wherein the processing unit is further configured to compute a reprojection error of the qualifying subset.

21. The apparatus of claim 20, wherein the qualifying subset is a first qualifying subset, the processing unit further configured to repeat (i), (ii), and (iii) to determine a second qualifying subset if the reprojection error of the first qualifying subset fails to satisfy a threshold condition.

22. A device comprising:
means for receiving at least one image of a physical environment;
means for identifying a plurality of line segments in the at least one image of the physical environment;
means for performing the following functions:
(iv) selecting a first subset of the plurality of line segments in the image;
(v) computing an angular distribution and a spatial distribution of the first subset of the plurality of line segments; and
(vi) determining whether the angular distribution and the spatial distribution of the first subset of the plurality of line segments satisfy predetermined angular and spatial criteria;
means for repeating (i), (ii), and (iii) with one or more new subsets of the of the plurality of line segments until a qualifying subset of the plurality of line segments is determined, the qualifying subset having a computed angular distribution and spatial distribution satisfying the predetermined angular and spatial criteria; and
means for providing the qualifying subset of the plurality of line segments.

23. The device of claim 22, further comprising means for determining a quality value for each line segment of the plurality of line segments, wherein selecting the first subset of the plurality of line segments is based on the quality value for each line segment.

24. The device of claim 22, wherein the image is captured with a camera of a mobile device, further comprising means for calculating a pose of the mobile device based on the qualifying subset.

25. The device of claim 22, further comprising means for determining, for each repetition of (i), (ii), and (iii), a value representative of a combination of the angular distribution and the spatial distribution.

26. The device of claim 25, further comprising means for determining a value for each of a plurality of subsets of the plurality of line segments, wherein the value of the qualifying subset represents the highest combined angular distribution and spatial distribution of the plurality of subsets.

27. The device of claim 22, further comprising means for computing a reprojection error of the qualifying subset.

28. A non-transitory computer-readable medium comprising instructions embedded thereon enabling line segment detection and matching in a computer vision application, the instructions including code, executable by one or more processors, for:
receiving at least one image of a physical environment;
identifying a plurality of line segments in the at least one image of the physical environment;
(i) selecting a first subset of the plurality of line segments in the image;
(ii) computing an angular distribution and a spatial distribution of the first subset of the plurality of line segments;
(iii) determining whether the angular distribution and the spatial distribution of the first subset of the plurality of line segments satisfy predetermined angular and spatial criteria;
repeating (i), (ii), and (iii) with one or more new subsets of the of the plurality of line segments until a qualifying subset of the plurality of line segments is determined, the qualifying subset having a computed angular distribution and spatial distribution satisfying the predetermined angular and spatial criteria; and
providing the qualifying subset of the plurality of line segments.

29. The non-transitory computer-readable medium of claim 28, further comprising code for calculating a pose of a mobile device based on the qualifying subset.

30. The non-transitory computer-readable medium of claim 28, further comprising code for computing a reprojection error of the qualifying subset.
